(19) United States
(12) Patent Application Publication
(10) Pub. No.: US 2009/0210200 A1
(43) Pub. Date: Aug. 20, 2009

(54) METHOD FOR PROVIDING OPERATING DATA OF A WIND FARM

(75) Inventors: Guntram KUNFT, Rendsburg (DE); Ralf ELSNER, Flensburg (DE); Markus BOOK, Kiel (DE); Matthias PRINZ, Felde (DE)

Correspondence Address: MORRISON & FOERSTER LLP, 1650 TYSONS BOULEVARD, SUITE 400, MCLEAN, VA, 22102, US

(73) Assignee: REpower Systems AG, Hamburg (DE)

(21) Appl. No.: 12/371,237

(22) Filed: Feb. 13, 2009

(30) Foreign Application Priority Data
Feb. 14, 2008 (DE) 10 2008 009 159.6

(51) Int. Cl. G06F 15/00; G06F 15/173

(52) U.S. Cl. 702/188; 709/203

(57) ABSTRACT

A method for providing operating data of a wind farm comprising a plurality of wind farm components. The operating data of the wind farm components are recorded and are stored in the relevant wind farm component. The operating data are sent to a plurality of receivers using a push method. The method simplifies the management of the operating data and requires only minimal transmission capacity in the data line of the wind farm component.

### REFERENCE TO RELATED APPLICATIONS

This application claims priority of German Patent Application No. 10 2008 009 159.6, filed Feb. 14, 2008, the contents of which are incorporated herein by reference in its entirety.

### FIELD OF THE INVENTION

The invention relates to a method for providing operating data of a wind farm. The wind farm comprises a plurality of wind farm components, operating data being recorded in each wind farm component. The operating data are stored in the relevant wind farm component.

### BACKGROUND OF THE INVENTION

Various conclusions on the operation of the wind farm can be drawn from the operating data. It is therefore customary for the operator responsible for proper operation of the wind farm and the wind farm components to evaluate the operating data. For this purpose, the operating data are transmitted to a computer centre belonging to the operator via a data line. Before transmission, the data in the wind farm are provided on data servers which are specifically set up for this purpose and read the data in the wind farm components, preprocess said data and transmit the latter to the computer centre in packaged form. Operation of the wind farm and the wind farm components can be optimized on the basis of the evaluation results or suggestions for an improved configuration of future wind farms can be obtained.

Since he is responsible for proper operation, the operator has access to the wind farm components. He can service the wind farm components, replace parts and make all modifications he deems necessary. In this context, it is readily possible for the operator to gain access to the operating data and to transmit, display and evaluate the operating data in any desired manner.

However, the customers using the electrical power produced in the wind farm are often also interested in obtaining the operating data in order to be able to evaluate the latter for their purposes. Unlike the operators, the customers do not have any direct access to the wind farm components but rather are dependent on the cooperation of the operator in order to obtain the operating data.

Hitherto, the customer has sent a request to the operator and requested the operating data to be sent for the purpose of evaluation. The operator has then accessed his stock of data, selected the desired operating data and sent them to the customer.

The operators sometimes run computer centres in which the operating data transmitted by a data server in the wind farm are stored. By means of a user identifier and password, the customers gain access to particular sections of the computer centre and may download the relevant operating data from the computer centre. This method has disadvantages. Firstly, managing access to the computer centre in such a manner that each customer gains access to precisely the operating data which are relevant to him is associated with some effort for the operator. Secondly, the operating data in the computer centre are no longer in raw form but rather the operator already had the opportunity to process the operating data. The data are regularly processed, for example, in such a manner that they are in a format which is favourable for evaluation. In addition, however, it is also readily possible for the operator to change the contents of the data. If it is taken into account that the operator and the customer have partly conflicting interests and that the operator may have significant interest in disseminating enhanced information relating to the operation of the wind farm, it is unsatisfactory for the customer to have to trust that he will receive uncorrupted operating data from the operator. In addition, it may be the case that the customer runs a plurality of wind farms which are operated by different operators. The operating data of the wind farms are then often not compatible with one another. The customer must make a considerable effort to obtain an overview of the wind farms and to evaluate the operating data of the latter.

The customers are therefore interested in gaining access to the operating data in the raw state before the operator has had the opportunity to change them. This interest is satisfied by allowing the customer to have access to the data server in the wind farm. Alternatively, the customer could be given access to a memory arranged in the wind farm component. However, in general, the data line which would make it possible for the customer to access the data server or the wind farm component with its memory is the same data line which is also used by the operator to carry out remote maintenance or install new control software. If the customer is intended to gain access to the wind farm component via this data line, it must be absolutely ensured that the customer's access is limited only to the operating data intended for the customer and that there is no possibility of influencing the control of the wind farm component. It involves considerable effort for the operator to ensure the required clear separation.

Furthermore, the first metres of the data line following the wind farm component are often narrowband. Only a classic modem is generally provided for data transmission in the wind farm component. If the customer now had the opportunity to access the wind farm component as desired in order to download operating data, the data line may be overloaded. There is the risk of the operator not being able to carry out maintenance because the data line is occupied with the downloading of operating data.

### SUMMARY OF THE INVENTION

The invention is based on the object of presenting a cost-effective and reliable method for providing operating data of a wind farm for the customers. The object is achieved by virtue of the fact that the operating data are sent to a receiver outside the wind farm using a push method.

Some terms are explained first of all. A wind farm comprises a plurality of wind energy systems in which wind energy is converted into electrical energy. In addition to the wind energy systems, a wind farm includes further wind farm components, for example a weather station and a main substation. In the main substation, the power produced is transferred to the public power network. Operating data are recorded in all wind farm components. The operating data relate to either ambient conditions or operating states of the respective wind farm component which are related to the power produced in the wind farm. Information which is not related to the production of power, for example the question of whether the entrance door of a wind energy system has been closed properly, is not operating data in the sense of the invention.

Operating data arising in the weather station may be, for example, the temperature, the wind speed and the atmospheric humidity. Operating data relating to the electrical power produced, the rotational speed, and fault messages are recorded in a wind energy system. The fault messages are related to the power produced; in particular, they may result in the relevant wind farm component being disconnected. In addition to a sequence of individual values, mean values over intervals of time are also usually stored. The voltage profile and the phase angle between the current and the voltage are stored as operating data in the main substation. Conclusions relating to the operation and behaviour of the wind farm and the wind farm components can be drawn from these operating data. A data server which is possibly present in the wind farm and is used only to store data arising in the wind farm, to manage data and to transmit data to the outside, that is to say does not undertake a control function for the other wind farm components, is not included in the term wind farm component. Such a data server does not contain data relating to ambient conditions nor operating states which are related to the power produced in the wind farm. No operating data in the sense of the invention are therefore recorded in the data server.

A sending method is referred to as a push method when the sending operation is initiated in the wind farm component. The start of the sending operation is dependent only on conditions which can be determined in the wind farm component itself. The operating data are therefore not sent immediately after they have been recorded but rather are first of all collected and stored in the wind farm component over a certain period of time and are sent when a predefined condition occurs.

A receiver is outside the wind farm when the operating data are transmitted from the wind farm component to the receiver by means of a data line which is no longer in the area of responsibility of the wind farm operator. The data line is outside the wind farm from a transfer point at which the customer is responsible for the data line. The operating data are sent directly from the wind farm component to the receiver outside the wind farm, that is to say the relevant receiver has already been determined in the wind farm component. The invention therefore does not relate to the situation in which the operating data are first of all sent from the wind farm component to a data server of the wind farm and are forwarded from there to a receiver outside the wind farm.

The invention presents a method which makes it possible to provide a receiver outside the wind farm with operating data in the raw state in a reliable and cost-effective manner. The fact that the operating data are sent directly from each wind farm component to the receiver dispenses with the need for a data server and a temperature-controlled server room in the wind farm. The costs are reduced and the reliability increases since fewer components which are prone to faults are used. The customer requirements are satisfied without the customer requiring data access to the wind energy system. The effort needed to process the data is reduced both for the customer and for the operator. If a data memory fails, the loss of data is restricted to the relevant wind farm component. The method results in a greater number of data connections in the wind farm but said connections have a smaller volume of data in total. Overall, the volume of data is smaller since each wind farm component no longer has to transmit all data to a data server which then selects the relevant data but rather only the relevant data are sent from the outset. The method according to the invention is particularly advantageous for the data line inside the wind farm, which is often narrowband, when the data are distributed among a plurality of receivers.

The receivers may be servers belonging to the customer or individual computers, for example in a control centre of the power supply system. The receivers may be far away from the wind farm and may be connected via the public Internet.

The conditions on which the initiation of the sending operation depends may be, for example, the expiry of a predefined period of time or the exceeding of a predefined quantity of operating data in the memory of the wind farm component. These events occur regularly and in a predictable manner. In one advantageous variant of the method, the sending operation is initiated on the basis of an irregular event. Such an irregular event may be, for example, a predetermined fault message or the disconnection of a wind energy system. In particular, the disconnection of a wind energy system or even of an entire wind farm creates problems for the power supply system because the missing feed power has to be replaced from other sources in the short term. The power supply system benefits a great deal if it has already received the information relating to the disconnection before the voltage drop rather than only by virtue of the voltage drop. Even a difference of only a few seconds may be valuable.

It is also possible to already send the operating data when an event which, with a certain degree of probability, will result in disconnection of the wind energy system occurs. This may be, for example, an increase in the wind speed or an increase in the generator temperature. The operating data transmitted in such a case may be an advance warning for the power supply system.

Irregular events in the wind farm component, the basis for which is outside the wind farm, are also included. For example, a receiver may inform the wind farm component that it wishes to transmit operating data. The receipt of the message in the wind farm component is an irregular event which the wind farm component may use as an opportunity to send the operating data to the relevant receiver.

As explained, the operation of sending the operating data may be initiated by different types of events. In one development of the invention, a decision is made regarding the receivers to which the operating data are sent on the basis of the type of event. Provision may thus be made for the operating data to be sent only to an individual receiver given a first type of event, for the operating data to be sent to receivers selected from a list given a second type of event, and for all receivers in the list to contain the data given a third type of event. As a result, the operating data are distributed more accurately. It may be the case, for example, that an operation of sending the data, which is initiated by a fault message from a wind energy system, is of interest only to the operator of the wind energy system and thus an individual receiver. In contrast, the operation of sending the data, which is initiated by expiry of a period of time, may enable statistical evaluation and may thus be of interest to a multiplicity of receivers.

Provision may be made for the times at which the operating data are sent from the wind farm component to the receiver to be preset. The operating data may be sent by different wind farm components at times which are coordinated with one another. The times may be coordinated with one another in such a manner that the operating data are sent at the same time. Overloading of the data line may be avoided by coordinating the times with one another in such a manner that the sending periods of a plurality of wind energy systems do not overlap.

The operating data may be sent to a plurality of receivers at the same time. Alternatively, it is possible for the sending times to be coordinated with one another, even in the case of a plurality of receivers and a plurality of wind farm components, in such a manner that the sending periods do not overlap.

The operating data may be permanently stored in the wind farm component. However, the storage capacity in the wind farm component will often be limited. It is advantageous when the operating data are erased from the memory of the wind farm component again at suitable times. However, the operating data should not be erased before the operating data have been successfully transmitted to all receivers. The erasing operation may also be made dependent on the fact that a predetermined period of time has elapsed since the operating data were recorded. It is likewise possible for the respective oldest operating data to be erased from the memory of the wind farm component when a particular volume of data or a particular number of data records is exceeded with the new operating data.

The information relating to the different receivers is preferably stored in the wind farm components. In addition to the respective receiver addresses, a data format in which the receiver wishes to receive the operating data may also be respectively stored. The data transmission security may be increased if the operating data are sent to the receiver in encrypted form.

The operating data are preferably stored in the wind farm component on a memory card. The memory card is a separate memory part which can be readily removed from the control unit of the wind farm component. It is also possible to access the operating data in this case when the data line which is normally used for access has failed. A service engineer may physically remove the memory card and read the operating data independently of the wind farm component and may send said data from his computer to the receivers or may process the data further for fault analysis.

Not all operating data which are recorded in the wind farm components are of interest to all receivers. For example, the operating data which relate to the electrical power produced and supplied are of interest to the customer, whereas the latter has no interest, for example, in fault messages which necessitate maintenance. From these points of view, the operating data may therefore be subdivided and stored in separate files. Only the files which are of interest to the relevant group of receivers are then sent and the remaining files are not sent.

In addition, the operating data may also be stored several times on a plurality of memory cards under separately adjustable criteria and may be sent to different receivers independently of one another according to points of view which are independent of one another, with the result that different customers are supplied only with the data relevant to them. For example, the average energy production and availability of the wind energy system may be of interest to the operator from economic points of view but should be transmitted only once a week, whereas the other instantaneous voltage values and currents which have been fed in must be transmitted hourly to the power supply companies for energy balancing in the electrical system.

If the customer is a power supply company, it has information, for example data relating to the power supply system, which the operator of the wind farm does not have. The customer can therefore use the operating data to carry out evaluations which are not possible for the operator. In order to make such evaluation results available to the operator as well, it is favourable to simply send said results back to the relevant wind farm component so that they can be stored there. If required, the operator can then access the customer's evaluation results. Direct contact between the customer and the operator is not required.

### BRIEF DESCRIPTION OF THE DRAWINGS

The invention is described by way of example below with reference to the accompanying drawing and using one advantageous embodiment. The FIGURE shows a wind farm with an associated data network.

### DETAILED DESCRIPTION OF THE INVENTION

A wind farm which is denoted 10 overall comprises a plurality of wind energy systems 11 with associated control units 12. The wind farm 10 also comprises a weather station 13 having a control unit 14 and a main substation 15 having a control unit 16. The control units 12, 14, 16 are parts of the relevant wind farm components.

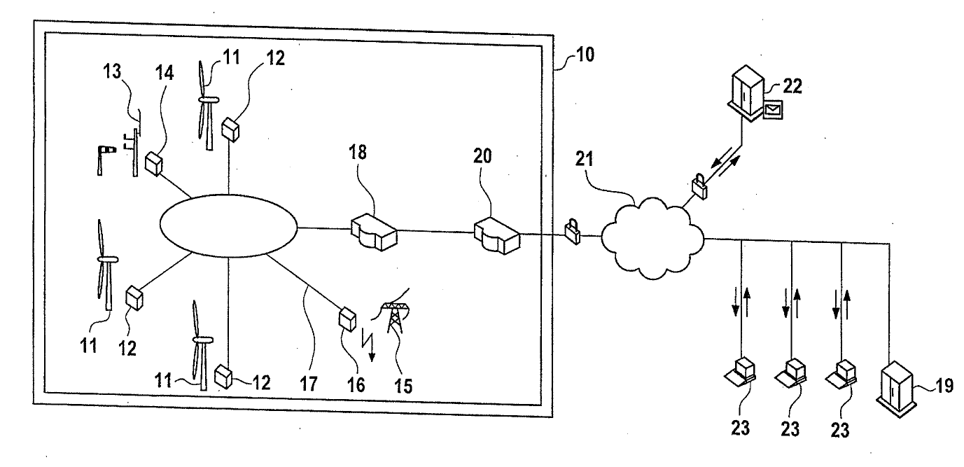

The control units 12, 14, 16 are connected to one another and to a router 18 by means of a data line 17. The data coming from the router 18 are encrypted using an encryption module 20 before they are transferred to the public Internet 21. The connection is thus secure with respect to third parties. The operator of the wind farm 10 is responsible for the data network up to the encryption module 20. On the other side of the encryption module 20, the responsibility for the data network lies with the customer who uses the power produced in the wind farm 10. Two servers 19, 22 and a plurality of clients 23 are connected to the data network of the wind farm 10 by means of the Internet 21. In the exemplary embodiment shown in FIG. 1, an encrypted connection is set up only to the server 22, whereas the connections to the server 19 and to the clients 23 are not encrypted. It is thus possible to individually select whether the connection should be encrypted and which key is possibly used.

Operating data relating to the wind farm components 11, 13, 15 and the ambient conditions are continuously recorded in the wind farm components 11, 13, 15. The operating data are stored in the control units 12, 14, 16 in memory cards (not illustrated). If a predefined condition occurs, for example expiry of a particular period of time, exceeding of a particular volume of data in the memory card or some other irregular event, the operating data are sent to the server 19, to the server 22 and to the clients 23. The customer can perform the desired evaluations with the operating data. Evaluation results which may be of interest to the operator of the wind farm 10 may be sent back to the wind farm components in the opposite direction and stored there.

The servers 19, 22 may be provided with different transmission protocols and methods, which are known per se, and may be in the form of FTP servers or SMTP servers, for example. In the latter case, the operating data are sent to predefined addresses in the form of emails.

1. A method for providing operating data of a wind farm comprising more than one wind farm component said method comprising the steps of:
a) recording operating data of a wind farm component;
b) storing the operating data in the wind farm component;
c) sending the operating data to a receiver outside the wind farm using a push method.

2. The method of claim 1, wherein the operating data are sent in step c) based on an irregular event.

3. The method of claim 2, wherein the irregular event is a message received in the wind farm component.

4. The method of claims 1, 2 or 3, wherein the operating data are stored in step b) in a memory card.

5. The method of claim 1, wherein the operating data are stored in step b) in subdivided form, and some of the operating data are not sent in step c).

6. The method of claim 1, wherein the operating data sent in step c) are evaluated, and a result of the evaluation is transmitted to the wind farm component.

7. The method of claim 1, wherein the operating data are sent to a plurality of receivers.

8. The method of claim 7, wherein the data are not erased from the memory of the wind farm component before the operating data are sent to the plurality of receivers.

9. The method of claim 1, wherein the operating data are transmitted to the receiver in encrypted form.

10. The method of claim 1, comprising recording operating data of a plurality of wind farm components storing the operating data in the associated wind farm component and sending the operating data to one or more receivers outside the wind farm using the push method, wherein the operations of sending operating data are coordinated with one another in terms of time.

11. The method of claim 10, wherein the sending operations are coordinated in terms of time in such a manner that sending periods of the plurality of wind farm components do not overlap.
